(19) United States
(12) Patent Application Publication
(10) Pub. No.: US 2005/0101179 A1
(43) Pub. Date: May 12, 2005

(54) Apparatus for and method of channel resource management

(75) Inventor: Chul-min Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/978,400

(22) Filed: Nov. 2, 2004

(30) Foreign Application Priority Data
Nov. 6, 2003 (KR) 2003-78331

(51) Int. Cl. H01R 33/02

(52) U.S. Cl. 439/488

(57) ABSTRACT

A method of channel resource management includes, upon receiving a passive open request signal or an active open request signal, checking the states of the plurality of sockets; and if at least one of the plurality sockets is not set up as a connection socket, setting up a socket as the connection socket and assigning the socket a channel.

### CROSS-REFERENCE TO RELATED APPLICATION

This application claims the benefit of Korean Patent Application No. 2003-78331, filed on Nov. 6, 2003, in the Korean Intellectual Property Office, the disclosure of which is incorporated herein by reference.

### BACKGROUND OF THE INVENTION

1. Field of the Invention

The present invention relates to a system for assigning channels using hardware sockets, and more particularly, to an apparatus for and method of effective channel resource management in the system.

2. Description of the Related Art

Hardware sockets such as transmission control protocol/Internet protocol (TCP/IP) user interface sockets are fixed resources for assigning channels. In addition, in conventional channel resource management with the hardware sockets, a single hardware socket is always assigned for a connection waiting channel at a passive open request, so that a system for assigning channels using the hardware sockets can operate server applications through the socket. However, in the conventional channel resource management, the socket assigned for the connection waiting channel at the passive open request can not be available for client application sockets, which may worsen channel shortage in a system that can operate both server applications and client applications.

### SUMMARY OF THE INVENTION

Additional aspects and/or advantages of the invention will be set forth in part in the description which follows and, in part, will be obvious from the description, or may be learned by practice of the invention.

An aspect of the present invention provides an apparatus for and method of channel resource management in a system for assigning channels using hardware sockets, in which all the hardware sockets can be assigned for available channels.

An aspect of the present invention provides another apparatus for and method of channel resource management in the system for assigning channels using the hardware sockets, in which all the hardware sockets can be assigned for channels when the system operates both server applications and client applications.

According to an aspect of the present invention, there is provided a method of channel resource management in a system using a plurality of sockets, the method comprising: upon receiving a passive open request signal or an active open request signal, checking the states of the plurality of sockets; and if at least one of the plurality sockets is not set up as a connection socket, setting up a socket as the connection socket and assigning the socket a channel.

According to an aspect of the present invention, the checking of the states of the plurality of the sockets is performed by referring to channel flags corresponding to the respective hardware sockets, which indicate whether the plurality of sockets are in a connected state.

According to an aspect of the present invention, if the socket is set up as the connected state, a channel flag corresponding to the socket is set to a value indicating the connected state.

According to an aspect of the present invention, while at least one socket that is not set up as the connection socket is being set up to be in a waiting state for the passive open request signal, when the active open request signal is received by the system, a socket is to be set up as a state for responding to the active open request signal.

According to an aspect of the present invention, the method further comprises establishing a socket through which communication has ended, to be in a waiting state for the passive open request signal.

According to another aspect of the present invention, there is provided an apparatus for channel resource management, comprising: a plurality of sockets, each of which is in one of a plurality of states; and a socket manager that sets up a socket of at least one sockets that is not set up as a connection socket and assigns the socket a channel when receiving a passive open request signal or an active open request signal.

According to an aspect of the present invention, the apparatus further comprises a channel flag unit including channel flags, each channel flag indicating a state of connection of each of the plurality of the sockets, wherein the socket manager refers to the channel flag so as to set up the socket as the connection socket, and updates a channel flag corresponding to the socket when receiving the passive open request signal or the active open request signal.

According to an aspect of the present invention, while at least one socket that is not set up as the connection socket is being set up to be in a waiting state for the passive open request signal, when the socket manager receives the active open request signal, the socket manager sets up a socket to be in a state for responding to the active open request signal.

### BRIEF DESCRIPTION OF THE DRAWINGS

The above and/or other aspects and advantages of the present invention will become more apparent by describing in detail embodiments thereof with reference to the accompanying drawings in which:

FIG. 1 is a functional block diagram of an apparatus for channel resource management, according to an aspect of the present invention; and

FIG. 2 is a flowchart illustrating a method of channel resource management, according to an aspect of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

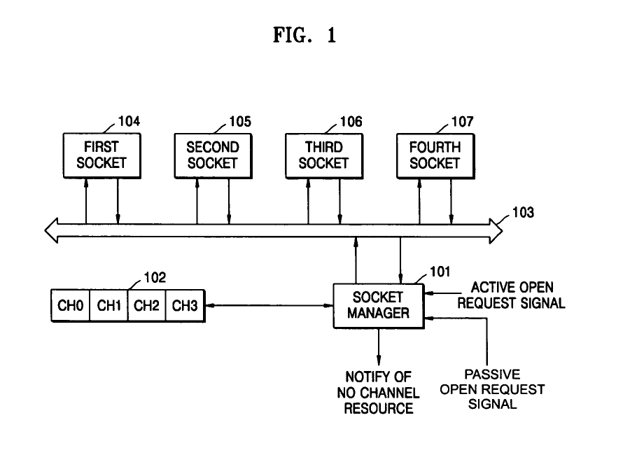

FIG. 1 is a functional block diagram of an apparatus for channel resource management, according to the present invention. Referring to FIG. 1, the apparatus includes a socket manager 101, a channel flag unit 102, a system bus 103, and first through fourth sockets 104, 105, 106, and 107. The socket manager 101 checks the connected state of each of the first through fourth sockets 104,105, 106, and 107 with reference to the channel flag unit 102, when an active open request signal or a passive open request signal is received. The active open request signal occurs when a corresponding system (Not shown) begins to perform client applications. The passive open request signal occurs when the corresponding system (Not shown) is performing server applications and a client requests a connection.

If it is determined that at least one socket of first through fourth sockets 104, 105,106, and 107 is not a connected socket, the socket manager 101 sets up the socket not connected as a connection socket and assigns a communication channel to the set up connection socket through the system bus 103. The socket manager 101 further updates the status of a channel flag corresponding to the set up connection socket in the channel flag unit 102 to reflect the current state of connection of the socket. That is, the socket manager 101 sets the channel flag to a predetermined value that indicates the socket is now a connected socket.

For example, if the second socket 105 is not in the connected state and an active or passive open request signal is received, the socket manager 101 sets up the second socket 105 as a connection socket through the system bus 103, and sets the corresponding channel flag, CH1, to a value that indicates the second socket 105 is in the connected state.

While a socket not being set up as a connection socket is in the waiting state for a passive open request, if the socket manager 101 receives an active open request signal, the socket manager 101 sets up the socket through the system bus 103 to respond to the active open request signal. Thereafter, if there is a socket through which communication ends, the socket manager 101 sets up the socket to be in a disconnected state through the system bus 103 and then sets up the socket to be in the waiting state for the passive open request signal. Simultaneously or slightly after this operation, the socket manager 101 sets the corresponding channel flag of the channel flag unit 102 to a predetermined value that indicates the socket is in the disconnected state.

Additionally, if the socket manager 101 determines that all of the first through fourth sockets 104, 105, 106, and 107 are connected sockets, the socket manager 101 notifies that there are no available channel resources to an apparatus (not shown) making the open request.

The channel flag unit 102 includes the same number of channel flags as the number of sockets in the system. In FIG. 1, since 4 sockets exist, the channel flag unit 102 includes 4 channel flags CH0, CH1, CH2, and CH3, each of which reflects the state of connection of the corresponding socket 104, 105, 106, or 107. However, it is understood that other numbers of channel flags can be used, and that

If a channel flag has been set to “0” and a corresponding socket is in the disconnected state, when the corresponding socket is set up as the connection socket, the channel flag is updated with “1” following the change in state of connection of the socket. On the other hand, if the channel flag has been set to “1” and the corresponding socket is in the connected state, when the corresponding socket changes to be in the disconnected state or in the connected waiting state, the channel flag is updated from “1” to “0”. As such, the socket manager 101 can know whether a socket among the first through fourth sockets 104, 105, 106, and 107 is not in the connected state by referring to the channel flag unit 102.

The system bus 103 is a path used to transmit information between the socket manager 101 and the first through fourth sockets 104, 105, 106, and 107, the information, for example, being generated by the socket manager 101 to set up the first through fourth sockets 104, 105, 106, and 107 to be in connection state or in a disconnection state.

The first through fourth sockets 104, 105, 106, and 107 are hardware sockets that can be set up by the socket manager to be in the connected state, the waiting state for the active open request or the passive open request, and the disconnected state. For example, in a system operating according to the TCP protocol, the states of the first through fourth sockets 104, 105, 106, and 107 may be set up as CLOSED, LISTEN, SYN_SENT, SYN_RCVD, ESTABLISHED, CLOSE_WAIT, LAST_ACK, FIN_WAIT1, FIN_WAIT2, CLOSING, or TIME_WAIT.

CLOSED indicates a disconnected state. LISTEN indicates an input waiting state during which a socket waits for the passive open request signal to be input. SYN_SENT indicates an input waiting state for an external response to be input during the active open state. SYN_RCVD indicates a waiting state for sending a response after receiving an external open request signal during the passive open state. ESTABLISH indicates a connected state. CLOSED_WAIT indicates a waiting (or passive end) state for sending an end message after receiving external end message. LAST_ACK indicates a waiting (or passive end) state for receiving an external response message after sending the end message. FIN_WAIT1 indicates a waiting (or active end) state for receiving an external response message or an external end message after sending the end message. FIN_WAIT2 indicates an extension state of FIN_WAIT1. CLOSING indicates another extension state of FIN_WAIT1. TIME_WAIT indicates a timer end state.

If the system based on the TCP protocol operates a server application, the state of a socket changes in the order of CLOSED, LISTEN, SYS_RCVD, ESTABLISHED, CLOSE_WAIT, LAST_ACK, CLOSED. On the other hand, if the system operates a client application, the state of a socket changes in the order of CLOSED, SYN_SENT, ESTABLISHED, FIN_WAIT1, FIN_WAIT2 or CLOSING, TIME_WAIT, CLOSED.

However, it is understood that for the purposes of embodiments of the invention, the states of the sockets can be roughly classified into the waiting state for the passive open request, the waiting state for the active open request, the connected state, and the disconnected state.

In FIG. 1, though only 4 sockets 104, 105, 106, and 107 are shown, the number of sockets, and accordingly the number of channel flags, can be any integer N, and the socket manager operates accordingly.

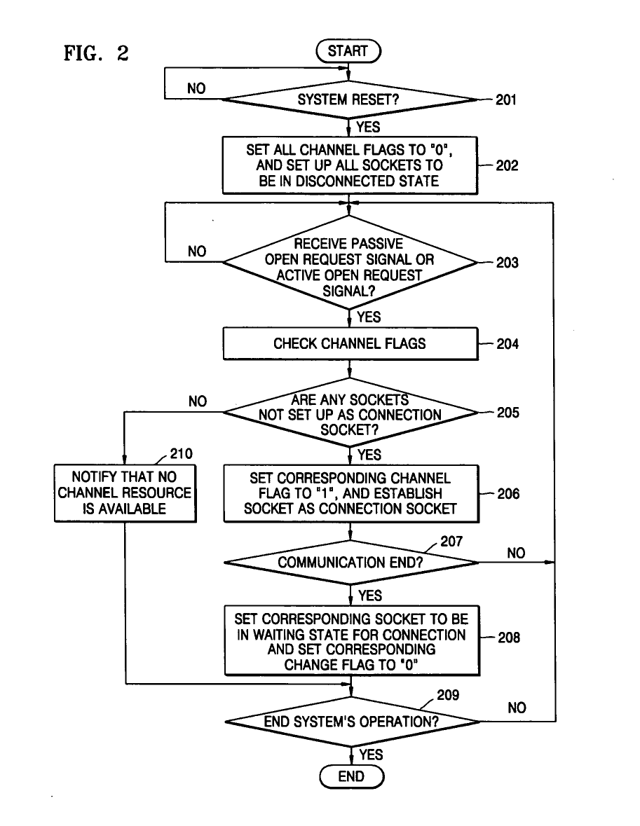

FIG. 2 is a flowchart that illustrates a method of channel resource management according to the present invention. While not required, it is understood that the method can be implemented using software executed on one or more computers. The method will now be described in conjunction with FIG. 1.

If it is determined that the system is reset in operation 201, in operation 202, the socket manager 101 sets up all the channel sockets 104, 105, 106, and 107 to be in the disconnected state or a closed state, and sets all the channel flags in the channel flag unit 102 to 0's.

When receiving a passive open request signal or an active open request signal in operation 203, the socket manager 101 checks the channel flags of the channel flag unit 102 in operation 204. However in operation 203, if the passive open request signal or the active open request signal is not received by the socket manager 101, the socket manager 101 waits until the socket manager 101 receives the passive open request signal or the active open request signal.

If the passive or active open request signal is received, the socket manager checks the channel flags 102 for t any one of the sockets 104, 105, 106, 107 is in a disconnected state in operation 205. In operation 206, the socket manager 101 sets a corresponding flag to “1” for a disconnected one of the sockets 104, 105, 106, 107, sets up the corresponding socket as a connection socket and assigns a channel to the socket.

If there is a request to end communication through the socket in operation 207, the socket manager 101 sets up the socket to be in the closed state or the disconnected state, and then sets up the socket to be in a waiting state for the passive open request while setting the corresponding channel flag to “0” in operation 208. If there is no request to end the communication through the socket in operation 207, the procedure returns to operation 203 and performs the above operations. Accordingly, while a communication channel has been assigned to a socket, a new communication channel can be assigned to another socket.

If the system is requested to end the system's operations in operation 209, the socket manager 101 finishes managing the first through fourth sockets 104, 105, 106, and 107. Otherwise, manager 101 returns to operation 203 and again performs the above operations.

Meanwhile, in operation 205 if there is no socket that has not been set up as the connection socket, in operation 210 the socket manager 101 notifies an apparatus requesting a socket in the open state, that there is no available channel resource, and the procedure goes to operation 209.

As described above, according to aspects of the present invention, hardware sockets are managed to be available in both the client applications and the server applications, thereby saving channel resources. In particular, when an active open request is made for a socket that has been established to be in a waiting state for a passive open request, the socket is managed to be available to respond to the active open request, and thus all the channel resources are effectively managed.

Although a few embodiments of the present invention has been shown and described with reference to preferred embodiments thereof, it will be appreciated by those skilled in the art that various changes may be made to the embodiments without departing from the spirit and scope of the invention, as defined by the appended claims and their equivalents.

1. A method of channel resource management in a system using a plurality of sockets, the method comprising:
checking states of each of the plurality of sockets when a passive open request signal or an active open request signal is received; and
setting up one of the plurality of sockets as the connection one socket and assigning the socket a channel if the one socket is not set up as a connection socket as determined by the corresponding state.

2. The method of claim 1, wherein the checking of the states of the plurality of the sockets is performed by referring to channel flags corresponding to the respective sockets each channel flag, which indicates whether a corresponding one of the plurality of sockets is in a connected state.

3. The method of claim 2, wherein, if the socket is set up as the connected state, the channel flag corresponding to the socket is set to a value indicating the connected state.

4. The method of claim 1, wherein, while at least one socket that is not set up as the connection socket is being set up to be in a waiting state for the passive open request signal, if the active open request signal is received, the socket previously in the waiting state is to be set up as a state for responding to the active open request signal.

5. The method of claim 1, further comprising establishing a socket through which communication has ended, to be in a waiting state for the passive open request signal.

6. An apparatus for channel resource management, comprising:
a plurality of sockets, each of which is in one of a plurality of states; and
a socket manager that sets up a socket of at least one sockets that is not set up as a connection socket and assigns the socket a channel when receiving a passive open request signal or an active open request signal.

7. The apparatus of the claim 6, further comprising a channel flag unit including channel flags, each channel flag indicating a state of connection of each of the plurality of the sockets selectable between a connected state and a not-connected state,
wherein the socket manager refers to the channel flag so as to set up the socket as the connection socket, and updates the channel flag corresponding to the set up connection socket when receiving the passive open request signal or the active open request signal.

8. The apparatus of claim 6, wherein, while at least one socket that is not set up as the connection socket is being set up to be in a waiting state for the passive open request signal, if the socket manager receives the active open request signal, the socket manager sets up the socket previously in the waiting state to be in a state for responding to the active open request signal.

9. The method of claim 1, further comprises
notifying that there are no available channel resources to an apparatus making the open request signal if all of the socket are the connected sockets.

10. The method of claim 1, further comprises setting up the corresponding channel flag to “1” if the socket is in one of the connected state and the not connected state, and the channel flag to “0” if the socket is in the other one of the connected and not connected states.

11. The method of claim 3, wherein the value indicating the connected state is a waiting state for the passive open request or one of a waiting state, a connected state or a disconnected state for the active open request.

12. The method of claim 10, further comprises setting up corresponding channel flag to “0” if the socket is returned to the disconnected state or the connected waiting state.
